(19) United States
(12) Patent Application Publication
(10) Pub. No.: US 2008/0140373 A1
(43) Pub. Date: Jun. 12, 2008

(54) APPARATUS AND METHOD FOR PREDICTING GENE MODULES USING GENE EXPRESSION AND TRANSCRIPTION FACTOR BINDING INFORMATION

(76) Inventors: Ho-Youl JUNG, Daejon (KR); Min-Ho KIM, Daejon (KR); Myung-Guen CHUNG, Incheon (KR); Po-Ra KIM, Daejon (KR); Seon-Hee PARK, Daejon (KR); Soo-Jun PARK, Seoul (KR)

Correspondence Address: LADAS & PARRY LLP, 224 SOUTH MICHIGAN AVENUE, SUITE 1600, CHICAGO, IL, 60604, US

(21) Appl. No.: 11/930,392

(22) Filed: Oct. 31, 2007

(30) Foreign Application Priority Data
Dec. 6, 2006 (KR) 10-2006-0123331

(51) Int. Cl. G06G 7/48

(52) U.S. Cl. 703/11

(57) ABSTRACT

Provided is an apparatus and method for predicting gene modules controlled by the same set of transcription factors and performing the same function in a cell, using gene expression data and transcription factor binding information. The apparatus includes: a gene expression similarity matrix generator for generating gene expression similarity matrix using gene expression data from external gene expression database; a gene expression similarity graph generator for generating gene expression similarity graph using the gene expression similarity matrix generated from the gene expression similarity matrix generator; a dense subgraph generator for generating dense subgraph by applying a dense subgraph algorithm to the gene expression similarity graph generated from the gene expression similarity graph generator; and a significant gene module generator for generating a significant gene module by extracting transcription factor binding information from an external transcription factor binding database using the dense subgraph generated from the dense subgraph generator.

### CROSS-REFERENCE(S) TO RELATED APPLICATIONS

The present invention claims priority of Korean Patent Application No. 10-2006-0123331, filed on Dec. 06, 2006, which is incorporated herein by reference.

### BACKGROUND OF THE INVENTION

1. Field of the Invention

The present invention relates to an apparatus and method for predicting gene modules; and, more particularly, to an apparatus and method for predicting gene modules (sets of genes) controlled by the same set of transcription factors and performing the same function in a cell, using gene expression data and transcription factor binding information.

This work was supported by the IT R & D of MIC/IITA [2005-S-008-02, “SW Component Development of Bio Data Mining & Integrated Management”].

2. Description of Related Art

First of all, terms to be used in the present invention will be defined as followings.

Corresponding mRNA expression patterns (gene expression data) of a gene given as an input generally refer to time-successive expression patterns created through a DNA chip experiment or data created by an experiment such as reaction with specific chemical substances.

Transcription binding information means that it can explicitly signify that a specific transcription factor is directly or indirectly bound to a promoter region of a specific gene to play a role in modulating the expression amount of the corresponding gene. In general, the transcription binding information can be obtained through an experimental method, e.g., chromatin immunoprecipitation-chip (ChIP-chip), and the previously known information relevant to transcription modulation can be obtained through a database, “TRANSFAC”. That is, the transcription binding information includes ChIP-chip experimental results or previously known data relevant to transcription factor-gene modulation, e.g., “TRANSFAC”.

Generally, pathogenesis or change of disease such as cancer occurs due to complicated processes inside/outside cells. The most important one of the complicated processes relates to a modulation mechanism of modulating the expression of a corresponding gene. The gene modulation is typically accomplished by transcription factors, which are genes (proteins) performing direct or indirect roles in modulating the gene expression.

Therefore, it is required a technology that can provide a macroscopic understanding about functions of transcription factors and genes in a cell after all by predicting a gene module which may be a large unit of the gene expression modulation mechanism.

Much interest is being focused on functional genomics including research and analysis for functions of genes since a genome sequence has been completed through the human genome project. An experimental tool, which is most beneficial to the functional genomics, is a DNA chip enabling experiments to be conducted massively. It is possible to experiment and analyze a set of genes performing the same function and purpose biologically rather than to predict the function of an individual gene unit in virtue of these massive experiments.

However, the experiment and analysis for a set of genes performing the same function and purpose biologically cannot be performed through a conventional separate experiment but can be performed through computation by “in silico” method. Herein, the “in silico” method refers to a computational method of solving a problem using a computation apparatus such as a computer.

A typical method, which has been popularly used, was to cluster genes using mRNA expression patterns. However, this typical method provides only the amount of information to such an extent that genes having similar expression values individually are grouped into one cluster simply. Hence, the typical method has a problem in that it is difficult to obtain practical information such as information about a set of genes controlled by the same transcription factors and performing similar roles in a cell.

That is, the typical method divides genes, which are numerically similar, into a plurality of clusters simply. Therefore, the typical method has a problem in that one gene cannot be included in a plurality of clusters by dividing genes into similar clusters of which expression values are wholly similar based on one cluster in consideration of functionalities.

### SUMMARY OF THE INVENTION

An embodiment of the present invention is directed to providing an apparatus and a method for predicting gene modules (sets of genes) controlled by the same set of transcription factors and performing the same function in a cell, using gene expression data and transcription factor binding information.

Another embodiment of the present invention is directed to provide an apparatus and a method for enabling one gene to be included in a plurality of clusters by dividing genes into similar clusters of which expression values are wholly similar based on one cluster in consideration of functionalities, while predicting gene modules (sets of genes) controlled by the same set of transcription factors and performing the same function in a cell, using gene expression data and transcription factor binding information.

In accordance with an aspect of the present invention, there is provided an apparatus for predicting gene modules using gene expression data and transcription factor binding information, the apparatus which includes: a gene expression similarity matrix generator configured to generate a gene expression similarity matrix using gene expression data from an external gene expression database; a gene expression similarity graph generator configured to generate a gene expression similarity graph using the gene expression similarity matrix generated from the gene expression similarity matrix generator; a dense subgraph generator configured to generate a dense subgraph by applying a dense subgraph algorithm to the gene expression similarity graph generated from the gene expression similarity graph generator; and a significant gene module generator configured to generate a significant gene module by extracting transcription factor binding information from an external transcription factor binding database using the dense subgraph generated from the dense subgraph generator.

In accordance with an aspect of the present invention, there is provided a method for predicting gene modules using gene expression data and transcription binding information, the method which includes the steps of: a) generating a gene expression similarity matrix using gene expression data; b) generating a gene expression similarity graph using the generated gene expression similarity matrix; c) generating a dense subgraph by applying a dense subgraph algorithm to the generated gene expression similarity graph; and d) generating a significant gene module by extracting transcription binding information using the generated dense subgraph.

In accordance with the present invention, a complete graph is generated in which a measured distance between genes is represented as an edge and the corresponding gene is represented as a vertex, and this complete graph is then simplified into a graph composed of edges belonging to the top n number of distances between genes (for example, the top 20% of all the distances between all the genes). Thereafter, a dense subgraph having high connectivity between vertices are calculated on this simplified graph, and then extracted as candidate sets of gene modules. Among these candidate sets, a set having high binding degree of a transcription factor is outputted as a final gene module.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a block diagram of an apparatus for predicting gene modules using gene expression data and transcription factor binding information in accordance with the present invention.

FIG. 2 is a flowchart illustrating a method for predicting gene modules using gene expression data and transcription factor binding information in accordance with the present invention.

FIG. 3 is an exemplary view illustrating an algorithm of extracting a dense subgraph allowing a gene overlap in accordance with the present invention.

FIG. 4 is a view illustrating a procedure of extracting the dense subgraph from gene expression data.

### DESCRIPTION OF SPECIFIC EMBODIMENTS

The advantages, features and aspects of the invention will become apparent from the following description of the embodiments with reference to the accompanying drawings, which is set forth hereinafter.

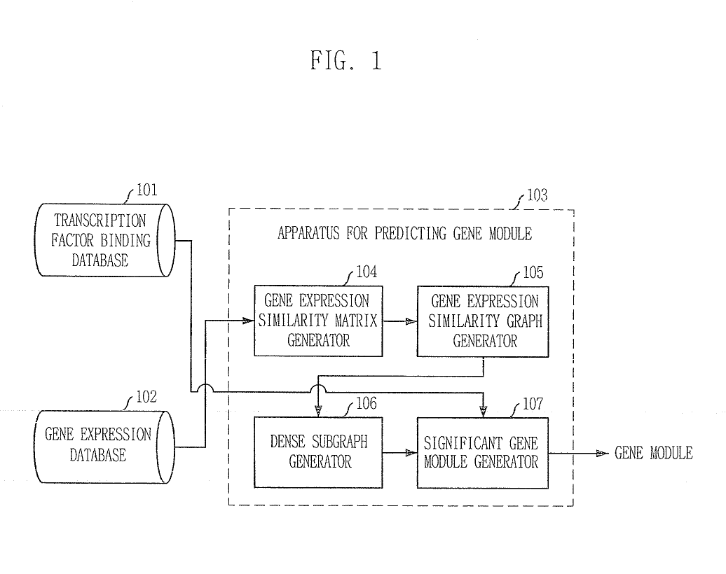

FIG. 1 is a block diagram of an apparatus for predicting gene modules using gene expression data and transcription factor binding information in accordance with the present invention.

In general, mRNA expression data of a gene can be represented as one vector for each gene and thus a similarity between two genes, i.e., a distance between the two genes, can be measured. A gene expression similarity matrix refers to a matrix obtained by measuring distances of all the gene pairs. An mRNA expression similarity graph (gene expression similarity graph) in which genes are represented as vertices and distances between the genes are represented as edges can be generated using the distances between all the genes in the gene expression similarity matrix.

Since the distances of all the gene pairs are measured, the gene expression similarity graph, which is primarily generated, is a complete graph. If the edges are removed on the basis of a specific critical distance value (dₜ), it is possible to simplify the complete graph into a general graph. At this point, the fact that two vertices (genes) are connected through an edge means that expression values of the two genes are similar to each other.

A dense subgraph is achieved from the gene expression similarity graph generated by the critical distance value (dₜ). Transcription factors bound to genes belonging to the dense subgraph are extracted from the transcription factor binding information received from a transcription binding information database and a significant dense subgraph is extracted, resulting in inventive gene module prediction using the gene expression data and the transcription binding information.

This will be more fully illustrated with reference to FIG. 1. Referring to FIG. 1, an apparatus 103 for predicting gene modules using gene expression data and transcription factor binding information in accordance with the present invention includes a gene expression similarity matrix generator 104, a gene expression similarity graph generator 105, a dense subgraph generator 106 and a significant gene module generator 107.

Here, a transcription factor binding database 101 used in the present invention stores transcription binding information, and a gene expression database 102 stores gene expression data, i.e., mRNA expression data of genes.

The gene expression similarity matrix generator 104 reads gene expression data from the gene expression database 102 and measures similarity distances of all the gene pairs to generate a gene expression similarity matrix.

The gene expression similarity graph generator 105 generates a gene expression similarity graph where a gene is represented as a vertex (v) and a distance, an element of the matrix, is represented as a weight (wₑ) of an edge (e) based on the gene expression similarity matrix generated from the gene expression similarity matrix generator 104.

The dense subgraph generator 106 generates a dense subgraph by applying a dense subgraph algorithm to the gene expression similarity graph generated from the gene expression similarity graph generator 105. The dense subgraph generator 106 generates a dense subgraph allowing a gene (vertex) to overlap.

The significant gene module generator 107 extracts transcription factor binding information from the transcription factor binding database to generate a significant gene module using the dense subgraph generated from the dense subgraph generator 106. That is, the significant gene module generator 107 outputs a gene and a transcription factor belonging to the significant dense subgraph as a gene module after calculating a transcription factor binding significance of the dense subgraph generated from the dense subgraph generator 106 in consideration of the transcription factor binding information from the transcription binding database 101.

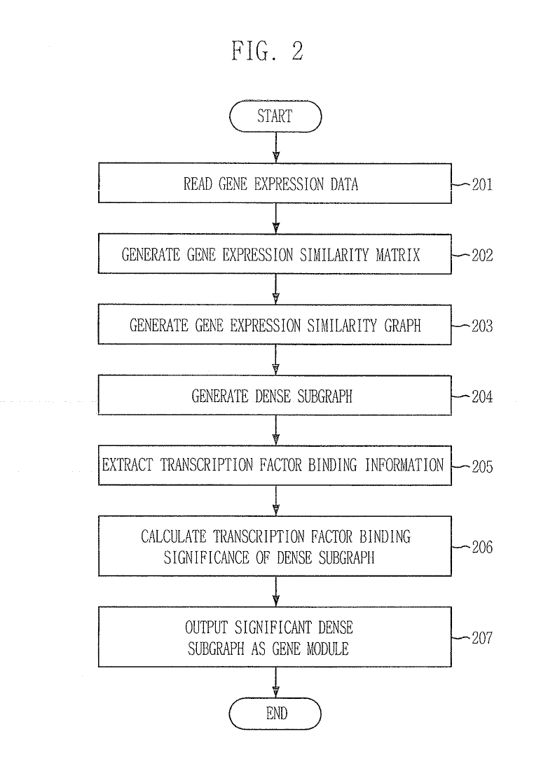

FIG. 2 is a flowchart illustrating a method for predicting gene modules using gene expression data and transcription factor binding information in accordance with the present invention.

First, the gene expression similarity matrix generator 104 reads gene expression data from the gene expression database 102 in step S201, and the gene expression similarity matrix is then generated by measuring a similarity distance between two genes for all gene pairs in step S202. A method for measuring a similarity distance between two genes may be performed using, for example, one selected from Pearson correlation coefficient, Euclidean distance and Spearman rank correlation coefficient.

Thereafter, the gene expression similarity graph generator 105 generates a gene expression similarity graph (G) where a gene is represented as a vertex (v) and a distance, an element of the matrix, is represented as a weight (wₑ) of an edge (e) based on the gene expression similarity matrix generated from the gene expression similarity matrix generator 104. In the case where the relation between the weight (wₑ) of the edge in the gene expression similarity graph generated from the gene expression similarity graph generator 105 and the specific critical distance value (dₜ) satisfies the following Equation 1, a corresponding edge (e) is removed from the gene expression similarity graph (G) to generate a gene expression similarity graph (G′) in step S203.

wₑ≧dₜ Eq. 1

where dₜ uses a value of the top p % in the weights of all the edges. The p serves as an input of a user, and generally p is 20.

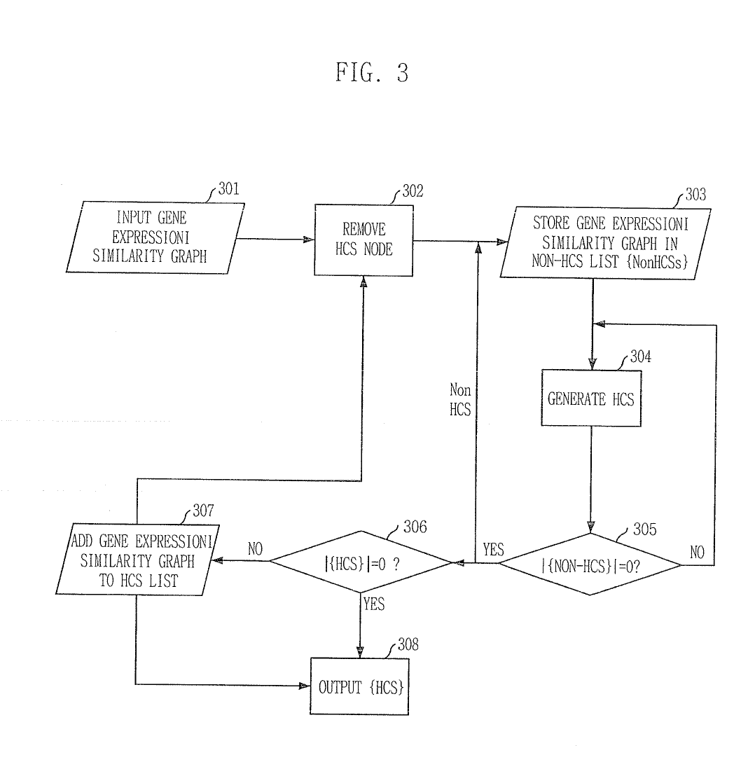

Afterwards, the dense subgraph generator 106 generates a dense subgraph (H) by applying a dense subgraph algorithm (this will be described more fully with reference to FIG. 3) to the gene expression similarity graph (G′) generated from the gene expression similarity graph generator 105. The dense subgraph generator 106 generates a dense subgraph allowing genes (vertices) to overlap in step S204.

Thereafter, the significant gene module generator 107 extracts transcription factor binding information from the transcription factor binding database in step S205 to generate a significant gene module using the dense subgraph generated from the dense subgraph generator 106 in steps S206 and S207. That is, the significant gene module generator 107 calculates a transcription factor binding significance of the dense subgraph generated from the dense subgraph generator 106 in consideration of the transcription factor binding information from the transcription binding database 101 in the step S206, and thereafter outputs the significant dense subgraph as a gene module in the step S207.

More specifically, if there is a modulation relation between the gene (V_{g}^{B}) and the transcription factor (Vₜ^{B}) for the transcription factor binding information of the transcription factor binding database 101, a bipartite graph where vertices are connected through an edge (E^{B}) is generated by the following Equation 2.

The binding significance of the transcription factor of the dense subgraph generated from the dense subgraph generator 106 is calculated in consideration of the transcription factor binding information from the transcription factor binding database 101 in the step S206. When the gene of the dense subgraph is denoted as V_{H}, the maximum bipartite subgraph including a set (Vₜ^{H}) of the transcription factors connected to V_{H} is expressed as the following Equation 3. If satisfying the following Equation 4, it is regarded that a graph is significant.

$$\begin{matrix}{G}^{B} = ( {V}_{t}^{B} + {V}_{t}^{B} , {E}^{B} ) & Eq . 2 \\ {G}_{{V}_{H}}^{B} = ( {V}_{t}^{H} + {V}_{H} , {E}_{H}^{B} ) & Eq . 3 \\ \vert {E}_{H}^{B} \vert \geq \frac{\vert {V}_{t}^{H} \vert \cdot \vert {V}_{H} \vert}{2} & Eq . 4\end{matrix}$$

where E_{H}^{B} denotes a set of edges connected to V_{H} and Vₜ^{H}. Genes (V^{H}) and transcription factors (Vₜ^{H}) belonging to the significant dense subgraph satisfying the Equation 4 are outputted as final results (gene modules) in the step S207.

FIG. 3 is an exemplary view illustrating an algorithm of extracting a dense subgraph allowing gene overlap in accordance with the present invention.

The dense subgraph described herein is defined by introducing concept of highly connected subgraph (HCS) that is disclosed in a document by Erez Hartuv and Ron Shamir, titled “A Clustering Algorithm Based on Graph Connectivity; Information Processing Letters, 76(2000), page 175-181”. The HCS means a subgraph having a high density. The high density is defined such that an edge connectivity k(G) is greater than half the number of vertices in a graph (G).

Referring to FIG. 3, a gene expression similarity graph is inputted in step S301. Because there is no HCS obtained in the first execution, the inputted gene expression similarity graph is stored in “Non-HCS list” in step S303. An HCS generation is performed in an HCS generator while taking out “NonHCS” one by one from the “Non-HCS list” in step S304. A subgraph of “HCS” is added to {HCS} list in step S307 and a graph of “NonHCS” is added to an initial {NonHCSs} list in the step S303.

It is confirmed whether or not “NonHCS” remains in the {NonHCSs} first inputted to the HCS generator in step S305. If it is confirmed that the “NonHCS” remains, the HCS generation is performed on the remaining “NonHCS” in the step S304. If it is confirmed that the “NonHCS” does not remain, it is confirmed whether or not the generated “HCS” exists in step S306.

If it is confirmed that the “HCS” does not exist, the “HCS list” which has been generated till now, is outputted in step S308. If it is confirmed that the “HCS” generated during this procedure exists, however, the gene expression similarity graph is added to the “HCS list, {HCSs}” and then HCS node removal operation is performed on the gene expression similarity graph in step S302, thus generating “HCS” and “NonHCS” repetitively.

In the present invention, one gene can be duplicately included in different “HCS” by performing the HCS generation in a following manner. That is, the “NonHCS” generated from the HCS generator is not added to {NonHCSs} used as an input of the HCS generator actually, but stored in another {NonHCSs} which serves as “Non-HCS list” during a next procedure. Then, the “NonHCS” generated from the HCS generator is substituted during the S305 step of confirming whether the “NonHCS” remains in the inputted {NonHCSs}.

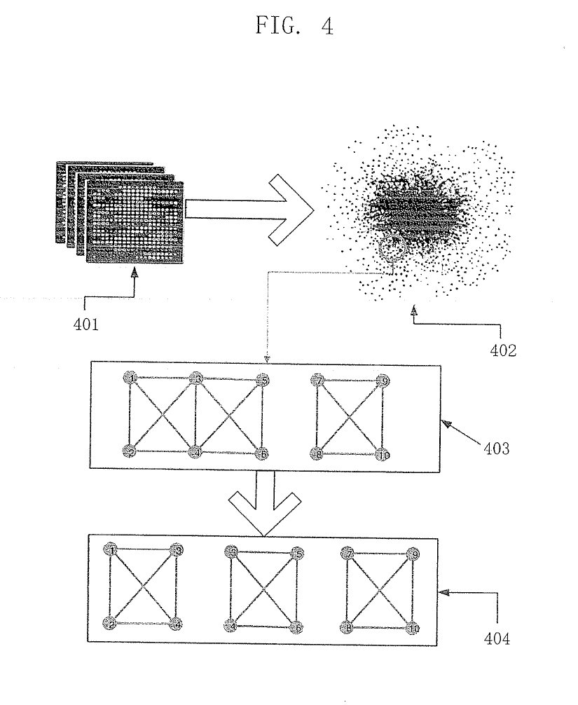

FIG. 4 is a view illustrating a procedure of extracting the dense subgraph from gene expression data. Referring to FIG. 4, a reference numeral “403” illustrates an enlarged view of a region denoted as a circle in a gene expression similarity graph 402 generated by measuring a distance between two genes of gene expression data 401. In FIG. 4, the reference numeral “403” represents a subgraph of the gene expression similarity graph 402, and includes two components.

A first component is composed of genes {1, 2, 3, 4, 5, 6}, and a second component is composed of genes {7, 8, 9, 10}. From the definition of the dense subgraph, a total number of possible dense subgraphs is 3 as illustrated in a reference numeral “404”, of which one is {1, 2, 3, 4}, another is {3, 4, 5, 6} and the other is {7, 8, 9, 10}.

Here, while {3, 4} must be selected between {1, 2, 3, 4} and {3, 4, 5, 6} in the conventional method, both {1, 2, 3, 4} and {3, 4, 5, 6} can be extracted as possible dense subgraphs.

The present invention described herein is very advantageous to understand a practical gene modulation mechanism in a cell, which was difficult to know through the typical gene clustering technique. It is possible to give overlap functions of a gene, which could not be realized in the typical method, so that a similar effect as a function of a gene in an actual cell can be achieved.

Further, in the case of performing such a work by biological experimental method, not computational method, it may be impossible or may be insufficient to extract even local meaning due to the loss of massive analysis effect using a typical technology, but the application of the present invention enables functions of genes in a cell to be macroscopically analyzed because the massive analysis is possible.

The methods in accordance with the embodiments of the present invention can be realized as programs and stored in a computer-readable recording medium that can execute the programs. Examples of the computer-readable recording medium include CD-ROM, RAM, ROM, floppy disks, hard disks, magneto-optical disks and the like.

In accordance with the present invention, it is possible to predict gene modules (sets of genes) controlled by the same set of transcription factors and performing the same function in a cell, using gene expression and transcription factor binding information, unlike the conventional method of providing only the amount of information to the extent that genes having similar expression values individually are grouped into one cluster simply.

Further, unlike the conventional method of dividing numerically similar genes into a plurality of clusters simply, one gene can be included in a plurality of clusters by dividing genes into similar clusters of which expression values are wholly similar based on one cluster in consideration of functionalities.

In addition, unlike the conventional method where it has taken much time and cost to perform biological gene modules while analyzing features and functions of all the genes, sets of genes (gene modules) controlled by the same transcription factors and performing the same biological function can be found out simply using gene expression and transcription factor binding information, which makes it possible to effectively reduce time and cost taken for experiments.

While the present invention has been described with respect to the specific embodiments, it will be apparent to those skilled in the art that various changes and modifications may be made without departing from the spirit and scope of the invention as defined in the following claims.

What is claimed is:

1. An apparatus for predicting gene modules using gene expression data and transcription factor binding information, the apparatus comprising:
a gene expression similarity matrix generator configured to generate a gene expression similarity matrix using gene expression data from an external gene expression database;
a gene expression similarity graph generator configured to generate a gene expression similarity graph using the gene expression similarity matrix generated from the gene expression similarity matrix generator;
a dense subgraph generator configured to generate a dense subgraph by applying a dense subgraph algorithm to the gene expression similarity graph generated from the gene expression similarity graph generator; and
a significant gene module generator configured to generate a significant gene module by extracting transcription factor binding information from an external transcription factor binding database using the dense subgraph generated from the dense subgraph generator.

2. The apparatus of claim 1, wherein the dense subgraph generator generates the dense subgraph allowing a gene overlap.

3. The apparatus of claim 1, wherein the significant gene module generator outputs a gene and a transcription factor belonging to a significant dense subgraph as a gene module after calculating a transcription factor binding significance of the dense subgraph generated from the dense subgraph generator in consideration of the transcription factor binding information from the transcription binding database.

4. The apparatus of claim 3, wherein the significant gene module generator expresses the transcription factor binding information of the transcription binding database as a bipartite graph of a gene and a transcription factor, and calculates a significance of a gene module using a density of the bipartite graph.

5. The apparatus of claim 3, wherein the gene expression similarity matrix generator reads gene expression data from the gene expression database, and generates the gene expression similarity matrix by measuring similarity distances of whole gene pairs.

6. The apparatus of claim 5, wherein the gene expression similarity graph generator generates the gene expression similarity graph in which a gene is represented as a vertex and a distance of a matrix is represented as a weight of an edge based on the gene expression similarity matrix generated from the gene expression similarity matrix generator.

7. A method for predicting gene modules using gene expression data and transcription binding information, the method comprising:
a) generating a gene expression similarity matrix using gene expression data;
b) generating a gene expression similarity graph using the generated gene expression similarity matrix;
c) generating a dense subgraph by applying a dense subgraph algorithm to the generated gene expression similarity graph; and
d) generating a significant gene module by extracting transcription binding information using the generated dense subgraph.

8. The method of claim 7, wherein the step c) comprises generating the dense subgraph allowing a gene overlap.

9. The method of claim 7, wherein the step d) comprises:
d1) calculating a transcription factor binding significance of the generated dense subgraph in consideration of transcription factor binding information; and
d2) outputting a gene and a transcription factor belonging to a significant dense subgraph as a gene module.

10. The method of claim 9, wherein, during the step d1), the transcription factor binding information is expressed as a bipartite graph of a gene and a transcription factor, and a significance of a gene module is calculated using a density of the bipartite graph.

11. The method of claim 9, wherein the step a) comprises:
a1) reading gene expression data;
a2) measuring similarity distances of whole gene pairs; and
a3) generating the gene expression similarity matrix.

12. The method of claim 11, wherein the step b) comprises the step of:
b1) generating the gene expression similarity graph in which a gene is represented as a vertex and a distance of a matrix is represented as a weight of an edge based on the generated gene expression similarity matrix.
